(19) United States
(12) Patent Application Publication
(10) Pub. No.: US 2010/0103512 A1
(43) Pub. Date: Apr. 29, 2010

(54) INSPECTION BLOCK FOR USE IN MICROSCOPIC INSPECTION OF EMBRYOS OR OTHER BIOLOGICAL MATTER INSIDE A CONTAINER UNIT AND METHOD OF MICROSCOPICALLY INSPECTING EMBRYOS OR OTHER BIOLOGICAL MATTER

(75) Inventors: CLAUDE RANOUX, WINCHESTER, MA (US); JOHN E. WALSH, NORFOLK, MA (US); JAMES A. LUDOVICZ, NORTH DIGHTON, MA (US)

Correspondence Address: YOUNG & THOMPSON, 209 Madison Street, Suite 500, Alexandria, VA, 22314, US

(73) Assignee: BIOXCELL INC., BEVERLY, MA (US)

(21) Appl. No.: 12/258,874

(22) Filed: Oct. 27, 2008

(51) Int. Cl. G02B 21/34; G02B 21/30

(52) U.S. Cl. 359/398; 359/395

(57) ABSTRACT

An inspection block is disclosed for use in inspection of biological matter in a container unit which has a chamber with transparent walls, the inspection block having a transverse docking passage for receiving and positioning a container unit, an observation chamber extending transversely relative to the docking passage and in communication therewith such that the biological matter located inside the container unit may be microscopically inspected through the chamber walls, transparent liquid for immersing at least part of the container unit so as to define a chamber wall/liquid optical interface for microscopic inspection therethrough. The inspection block may be made of steel, aluminum or plastic. In the latter case, the plastic inspection block may have closed cavities for containing insulating blocks and/or one or more downwardly opening air pockets retaining heat given off by a warmed work bench and/or warmed microscope stage on which the inspection block is supported during inspection.

### FIELD OF THE INVENTION

1. Background of the Invention

The present invention relates to an inspection block for holding a container for biological matter, e.g. one or more embryos, or any other biological tissue, in order to observe the biological matter microscopically.

2. Discussion of the Prior Art

Intravaginal culture (IVC), which has been developed by the assignee of the present application as is also known as the INVO™ process comprises maturation of gametes, fertilization of oocytes and embryo development in a sealed container filled with a suitable culture medium which is placed in the vaginal cavity. The vaginal cavity is used instead of a 5% CC2 incubator conventionally employed for IVF.

The IVC container assembly is disclosed in Ranoux et al. U.S. Pat. No. 6,050,935 the content of which is hereby incorporated by reference, and comprises a container body and a resealable closure for selectively opening and closing a container body orifice. The container body has a main chamber with a generally cylindrical sidewall and a microchamber in communication with the main chamber to permit the movement of one or more embryo(s) into and out of the microchamber. The microchamber has sidewalls of optical quality permitting microscopic inspection of embryos. The microchamber also facilitates the retrieval of one or more embryo(s) by means of a catheter without having to remove them from the container or otherwise endangering them.

Microscopic inspection of embryo(s) and the loading of the embryo(s) into a catheter for transfer to a patient's uterus for implantation are two operations performed after fertilization and culture that is after the container assembly is removed from the vaginal cavity. The embryo(s) remain inside the container body and are observed, selected and loaded into a catheter from the microchamber without transfer to a culture dish.

During these operations which normally take about 10 minutes, the container unit is exposed to ambient temperatures, typically about 20-25° C., significantly less than 37° C. and a different gaseous environment. Such changes in the environmental conditions may dramatically affect the quality of the embryo(s). To mitigate the cooling of the contents of the container unit, the container unit may be positioned in a so-called isothermal block designed to permit microscopic observation of the embryo(s) in the microchamber as disclosed in US patent application No. 2004/0157205 filed Feb. 10, 2003, published as U.S. published patent application No. US2006/0228794 and assigned to the assignee of the present application, the content of which is hereby incorporated by reference. In US2006/0228794 there is disclosed a pre-heated isothermal holding block preferably made of steel or any other material having a relative high thermal inertia. Such a holding block has a lateral bore for receiving the container assembly either with the outer shell in which case the outer shell has a further surface of optical quality, or without the outer shell. The embryo(s) in the container can be inspected under a microscope through a vertical bore lit from below. The isothermal holding block is heated to the desired temperature of about 37° C. and may be equipped with a heating element so that the container may be maintained at such a temperature when shipped or transported to another location.

The observation of embryo(s) in the microchamber of the container assembly such as disclosed in US2006/0228794 at appropriate high levels of magnification reveals artifacts which may interfere with the location of the embryo(s) in the microchamber and their inspection. Two types of artifacts have been detected. The first type of artifact comprises shadows caused by microscopic irregularities of the surface roughness of the two main flat outer surfaces of the microchamber through which the embryo(s) or other biological matter is viewed. Such artifacts are observable (albeit less frequently) even when such surfaces have been highly polished and are of optical quality. Some shadows are of electrostatic origin, causing dust particles to adhere to outer surfaces of the microchamber.

The second type of artifact comprises large shadows surrounding the microchamber caused by the curved surfaces of the microchamber which refract the light beam of the microscope. Such curved surfaces are found on the bottom and the narrow side walls of the microchamber. Also, the inclination of the generally frustoconical sidewall of the main chamber, tapering towards the parallelepipedic microchamber or any curved surface of container unit will cause distortion of the images of the embryo(s) or of the biological matter to be observed.

Immediately after vaginal incubation, the container unit may be placed in a vertical position in an incubator at 37° C. for an additional 15 minutes. The embryo(s) or other biological matter will then settle to the bottom wall of the microchamber in such a position. In these conditions, shadows which are caused by the bottom wall of the microchamber are also often detrimental to good observation of embryo(s) or other biological matter.

Note that in conventional IVF, the observation of the embryo(s) in a conventional culture dish and the loading of the catheter for embryo transfer to the uterine cavity may also affect embryo quality. These operations are performed in a laboratory at temperatures well below 37° C. and in a normal ambient air environment (without 5% CO2). The culture medium with the embryo(s) in the culture dish may be covered by a film of mineral oil to reduce the impact of this modified gaseous environment on the embryo(s) and the lower ambient temperatures. In conventional IVF, a culture dish with a suitable culture medium, a microscope warmed platform and/or placed in a mini-incubation chamber with a 5% CO2 air atmosphere may be employed.

### SUMMARY OF THE INVENTION

One object of the invention is to mitigate or eliminate such artifacts during location or microscopic observation of embryo(s) or other biological matter in a container unit or the like.

A more general object of the present invention is improved microscopic observation of any biological matter in a chamber through a vessel or container unit wall which is otherwise apt to produce undesirable artifacts.

Another object is an inspection block compensate for heat given off by the inspection block to the ambient atmosphere.

According to a first aspect of the present invention, embryo(s) are microscopically inspected through transparent wall(s) of a chamber of the container unit at least partly surrounded by a suitable transparent liquid having a relatively refractive index to mitigate or eliminate artifacts otherwise caused by defects in the surface finish and/or the configuration of the transparent wall(s) of the container.

According to a second aspect of the invention, there is provided an inspection block for use in inspection of embryos in an embryo container having a chamber with transparent walls, the inspection block having a transverse docking passage or bore for receiving and positioning an embryo container unit, an observation chamber extending transversely relative to the bore and containing a suitable transparent liquid having a relatively high refractive index, the observation chamber being in communication with the transverse docking passage, such that embryos located inside the chamber may be microscopically inspected in the observation chamber through a transparent liquid/chamber wall optical interface. The docking passage may have the same shape as the outer surface of the container unit so that the docking passage determines the angular and axial position of the container unit relative to the docking passage. In the case of a cylindrical or conical container unit surface, the sidewalls thereof may have one or more fins and the docking passage a corresponding slot to determine the relative axial position of the container unit relative to the docking passage.

According to a third aspect, there is provided a method of microscopically observing biological matter, including embryos, in a suitable biological medium and accommodated in a transparent chamber, comprising the steps of: immersing at least part of the transparent chamber in a transparent liquid having a relatively high refractive index, so that the transparent liquid defines an optical interface with at least an external surface of the transparent chamber and observing the biological matter in the chamber through the optical interface and thereby reducing or eliminating artifacts able to be caused by the wall(s) of the chamber.

In practice, the relatively high refractive index transparent liquid may be microscope oil, mineral oil, paraffin oil or some other nontoxic transparent liquid having an index of refraction between about 1.45 and about 1.65 and more particularly between about 1.50 and about 1.60. One suitable mineral oil is Type B microscope immersion oil available from Cargille Laboratories which has a refractive index of 1.515.

Advantages of the present invention include the reduction or elimination of shadows caused by imperfections of the outer surfaces of the microchamber or curved surfaces of the chamber walls.

If the chamber which may comprise a microchamber is immersed in a microscope oil, mineral oil, paraffin oil or another suitable non-toxic transparent liquid, the oil or other suitable transparent liquid will in effect “fill in” surface imperfections and tend to reduce refraction caused by surfaces, thereby eliminating distortions and shadows of the light beam. The resulting quality of embryo observation in the microchamber is at least as good as embryo observation in a conventional culture dish where one faces none of the optical challenges inherent in a very small chamber, such as a microchamber with inevitable external surface roughness and/or marked changes in curvature, while at the same time retaining all the advantages of microscopic observation of embryo(s) in such a microchamber.

The oil or other relatively high refractive index transparent liquid advantageously contributes to the maintenance of temperatures over 34° C. for at least 7 minutes and preferably up to at least 10 minutes, necessary for safe inspection prior to transfer of the embryo(s) to the uterus. A further advantage of the use of such an oil or other suitable relatively high refractive index transparent liquid us that it acts as a buffer against the exchange of gas through the gas permeable wall of the container, thereby maintaining pH of the culture medium in the chamber relatively stable and between around 7.2 to around 7.4 even without a 5% CO2 air atmosphere. For this purpose the oil or other relatively high refractive index transparent liquid may have a viscosity of greater than about 800 centistokes.

According to an embodiment of the present invention, a liquid reservoir is provided for temporary storage of the oil or other suitable relatively high refractive index transparent liquid when the inspection block is not in use. Preferably, the reservoir is in fluid communication with the observation or immersion chamber of the inspection block.

According to an embodiment, the inspection block has a standby position where the oil or other suitable relatively high refractive index transparent liquid is in storage in the reservoir and an inspection position where the oil or other suitable transparent liquid immerses at least part of the chamber which may be a microchamber for the embryo(s) or biological matter, so that the embryo or other biological matter may be microscopically observed through an oil or other suitable transparent liquid/transparent chamber wall optical interface.

The reservoir or immersion chamber together may be part of an oil or other suitable transparent liquid circuit, the inspection block having at least one passageway for purging or venting air from the oil or other suitable transparent liquid circuit to the surroundings.

Thanks to the possibility of transferring oil or other suitable transparent liquid from the immersion chamber to the reservoir, the risk of spillage of oil or other suitable transparent liquid on the microscope stage can be reduced or entirely eliminated.

Also, a gasket may be provided between the container unit and the container unit receiving portion defined by a transverse docking passage in the block to eliminate or impede spillage of oil or other suitable transparent liquid when the container lodged in the container unit receiving portion. It will eliminate or impede any spillage of oil or other suitable transparent liquid during the introduction of the container unit into the block or the removal of the container unit from the block.

Such an inspection block may be made of steel, preferably stainless steel or aluminum and comprise one or more cast and/or machined components fixed together. Alternatively the inspection block, or may be of plastic and preferably mainly or entirely transparent plastic. Such a plastic inspection block may comprise a main injection molded component or a plurality of injection molded components bonded or welded together with or within threaded fasteners. The plastic inspection block may be a relatively thick-walled construction like a metal casting or a relatively thin-walled construction comprising a hollow housing filled with insulating air or foam.

The inspection block may comprise one main casted or molded components with several additional components for example to close the ends of the longitudinal bore defining the reservoir for the transparent liquid and in the case of a metal inspection block to define a sealed light window at the lower end of the observation chamber between the portion of the container unit received therein and the light source such as a microscope light source.

While a stainless steel or other block of metal such as aluminum is relatively heavy and has the advantage of being particularly stable when positioned on a microscope stage or platform during the observation of one or more embryos or other biological matter and loading the embryo(s) into a transfer catheter it is relatively expensive to manufacture and ship to customers. A stainless steel block exhibits high thermal inertia or capacity, so that its temperature (and that of the culture medium and biological matter, e.g. one or more embryos inside the container) is maintained above the minimum temperature for minimum time necessary for location, inspection, selection and/or retrieval of the embryo(s) or the handling and/or selection, manipulation and/or transfer of some other biological matter.

In practice a stainless block which is initially heated and held at approximately 37° C. for 90 minutes will remain at least 34° C. for at least 10 minutes. Tests show that in practice such a stainless block containing a suitable transparent liquid such as microscope oil or mineral oil heated to 37° C. and left at ambient temperature of 20°-23° C. may maintain its temperature and that of the contents of the container unit held in the inspection block at at least 34° C. for 12.5 minutes.

After the block is left at ambient temperature for, say, 10-12 minutes, reheating and temperature stabilization at about 37° C. in the incubator will take about 45 minutes.

For such purposes the inspection block temperature is deemed stabilized when it cycles in an incubator within a range of about plus and minus 1° C. around the target temperature.

Testing on an inspection block of the same configuration but made of aluminum and containing a suitable transparent liquid such as microscope oil, mineral oil or paraffin oil having a relatively high refractive index shows that such an inspection block may maintain its temperature and that of the contents of the container at at least 34° C. for 7 minutes.

The temperature of the inspection block which drops only 3° C. in 7 minutes will be satisfactory when the container is used for an IVC or INVO™ process.

An experienced laboratory technician may be able to locate, inspect, select and then load in a catheter the one or more embryo(s) using the container and isotherm heating block disclosed in US2006/0228794 in 4 minutes or less. Even a relatively inexperienced laboratory technician can carry those steps in less than 7 minutes. The use of the inspection block made of cast aluminum will be more than satisfactory to enable these steps to be carried out so that the temperature of the block and the contents of the container unit do not fall below about 34° C. in less than 7 minutes.

Testing on an inspection block of the same general configuration but made of a plastic material having a relatively high thermal inertia or capacity such as polystyrene and containing a mineral oil shows that such an inspection block may maintain its temperature and that of the contents of the container at at least 34° C. for about 9.5 minutes.

The performance of such a polystyrene or other relatively high thermal inertia or capacity material may be increased by making the block a hollow-wailed housing with closed cavities filled with an insulating gas such as air which has a low thermal conductivity of 0.024 W/mK or expanded polystyrene foam which has a comparable low thermal conductivity of 0.03 W/mK.

Such a hollow-walled housing with insulating cavities may maintain its temperature and that of the contents of the container at at least 34° C. for 10.5 minutes which for reasons given above will be more than satisfactory to locate, observe, select and then load two or more embryo(s) using a catheter and for other purposes when other biological matter is to be inspected and handled.

In practice the period during which the inspection block may be held at a temperature of at least 34° C. may be even longer than indicated above which will be useful for more complex or difficult situations. The inspection block may be supported on a warmed work bench or warmed microscope platform or stage the heat of which will compensate for at least part of the heat loss of the inspection block to the ambient air surroundings at 20° C.-23° C.

According to a fourth aspect of the invention there is provided an inspection block for use in inspection of biological matter in a container unit having a chamber with transparent walls, said inspection block having a bore for receiving and positioning a container unit, an observation chamber extending transversely relative to the bore and in communication therewith such that the biological matter located inside the container unit may be microscopically inspected through the chamber walls, the inspection block being of thin-walled construction, e.g., of transparent plastic, having one or more downwardly opening air pockets for retaining heat given off by a warmed work bench and/or warmed microscope stage. It goes without saying that such a block may contain a suitable transparent liquid having a relatively high refractive index for improving the inspection of the embryos or other biological matter in the container unit.

Other features or properties of the present inspection block may assist in ensuring that temperatures do not drop below the desired minimum temperature.

Indeed, the presence of the transparent high refractive index liquid in the block increases the total mass of the block which is heated and stabilized at the target temperature, e.g. of about 37° C. for embryo inspection.

The presence of one or more downwardly opening air pockets on the underside of the block of plastic in the inspection position serves to trap heated air rising from the warmed work bench and/or warmed microscope platform or stage to compensate for hit lost to the ambient air surroundings.

A rectangular cross-sectional the longitudinal bore defining the liquid reservoir may be used to increase the effective volumetric capacity of the liquid reservoir and thereby the corresponding volume and mass of the oil or other transparent relatively high refractive index transparent liquid.

A clear or transparent plastic material block of polycarbonate, polystyrene polyester or the like will increase the light intensity inside the lateral bore or container unit recess and inside the chamber of the container unit itself, thereby improving the optical vision of the embryo(s) or other biological matter in the container unit.

The present invention will now be described by way of non-limiting example with reference to the accompanying drawings.

### BRIEF DESCRIPTION OF THE DRAWINGS

FIG. 1 is a perspective view of a first embodiment of an inspection block according to the invention in which a container unit is received in the inspection block for microscopic observation of biological matter, such one or more embryos, in the chamber of the container unit;

FIG. 2 is a perspective view similar to FIG. 1 but where the hollow portions of the inspection block are shown in solid one to enhance clarity;

FIG. 3 is a cross-sectional view taken along line III-III of FIG. 2 where the inspection block is in an observation position;

FIG. 4 is a cross-sectional view similar to that of FIG. 3 where the inspection block is in a standby or loading/unloading position for use when introducing or removing the container unit from the inspection block;

FIG. 5 is a perspective view of a second embodiment of an inspection block according to the invention in which a container unit is received in the inspection block for microscopic observation of biological matter, such one or more embryos, in the chamber of the container unit;

FIG. 6 is a longitudinal sectional view taken along line VI-VI of the inspection block of FIG. 5;

FIG. 7 is another longitudinal sectional taken along line VII-VII of inspection block of FIG. 5;

FIG. 8 is a front view of the inspection block of a third embodiment according to the invention in its observation position;

FIG. 9 is a bottom view of the third embodiment the inspection block according to the invention for receiving a container unit for microscopic observation of biological matter, such one or more embryos, in the chamber of the container unit;

FIG. 10 is a rear view of the inspection block of the third embodiment; and

FIG. 11 is an end view of the inspection block of the third embodiment.

### DETAILED DESCRIPTION OF EMBODIMENTS

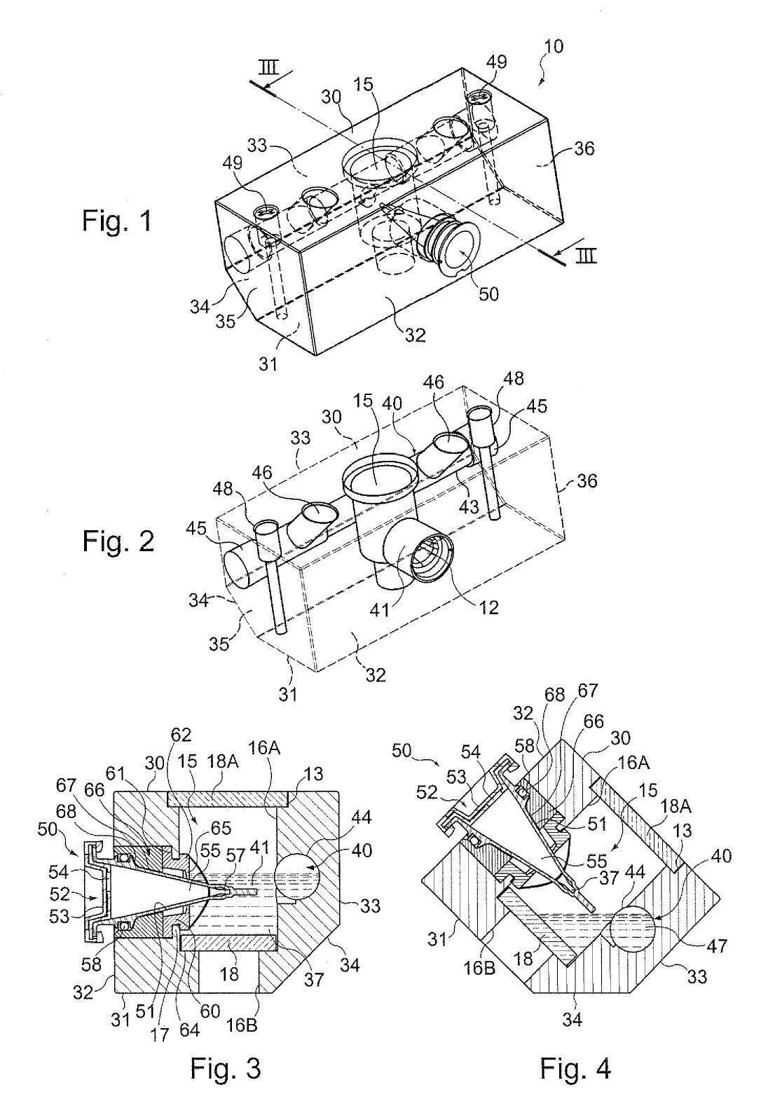

As illustrated in FIGS. 1 and 2, the inspection block 10 is generally parallelepipedic and has a top wall 30, a bottom wall 31, front wall 32 and rear wall 33 and an oblique or inclined wall 34 extending between the bottom wall 31 and the rear wall 33 and a pair of opposed end walls 35 and 36. Such a block may be made of steel, e.g., stainless steel. The high specific gravity of steel and the configuration of the inspection block ensure that the block is stable when supported on the microscope stage or platform during observation and loading of embryo(s). Such a relatively thick-walled steel inspection block provides high thermal inertia or heat retaining capacity to maintain the temperature of the block over 34° C. for at least 10 minutes, and according to tests for up to 12.5 minutes without the need for active heating of the block. Ten minutes is normally more than enough even for an inexperienced laboratory technician to locate, observe and select embryo(s) in the microchamber and load them into a transfer catheter while being viewed under the microscope. Alternatively, the block may be made of aluminum or a plastic material such as polystyrene which also has high thermal inertia or heat retaining capacity to ensure that such a thick-walled block maintains the temperature above the minimum temperature for the requisite period.

The inspection block 10 has a transverse docking passage 12 which extends inwardly from front wall 32 and preferably has a generally frustoconical or cylindrical sidewall corresponding generally to the overall outer shape of the container unit 50, which as shown is the inner vessel described and illustrated in detail in the aforesaid U.S. published patent application No. US2006/0228794. It goes without saying that the design of the container unit is given by way of example and that other vessel or container unit designs and configurations may be adopted without departing from the scope of the present invention.

As illustrated the container unit 50 comprises a vessel body 51 of cylindrical or substantially frustoconical shape. An annular outwardly opening groove accommodates an O-ring 58. A closure device 52 is located at the large or proximal end of the frustoconical vessel body, and includes a rotatable valve member 53 for opening and closing an access opening 54 into a chamber, here main chamber 55. The chamber, as illustrated, comprises at the distal or lower end of the main chamber 56 a microchamber 57 having a pair of main flat sidewalls of optical quality for facilitating microscopically observation of biological matter in the chamber, here one or more embryos.

The length of the transverse docking passage 12 is less than the length of the container unit 50 so that the lower or distal end thereof including the microchamber 57 extends beyond the inner end of the transverse docking passage 12 into an observation chamber or channel 15 which extends the top wall 30 towards the bottom wall 31. The transverse docking passage 12 has an enlarged recess 13 immediately inwardly of the front wall 32. The enlarged recess 13 is adapted to accommodate and snugly engage the O-ring 58 located in the radially outwardly opening annular groove of the outer surface of the vessel body, thereby defining the axial position of the container unit relative to the transverse docking passage 12 and likewise the position of the chamber, here microchamber 57, relative to the observation chamber 15. The complementary shape of the transverse docking passage 12 allows the operator to rotate the entire container unit 50 until the main opposed flat surfaces of the microchamber 57 or other viewing zone of any such vessel are substantially perpendicular to the axis of the observation chamber 15. The operator can also rotate the mobile disc shape valve member 53 and thereby open the valve with one hand in order to introduce a transfer catheter (not shown) through the opening 54 and into the main chamber 56 or microchamber 57 of the vessel in position in the transverse docking passage 12 with a view to loading biological matter, this case one or more embryos into the catheter for transfer to a recipient.

The observation chamber 15 comprises, as illustrated, an upper cylindrical portion 16A of relatively large diameter (e.g. about 10 mm) and a lower cylindrical portion 16B having a smaller diameter (e.g. about 5 mm), extending from the top wall 30 to the bottom wall 31 of the block. An annular shoulder 17 at the bottom end of the upper cylindrical portion 16A receives a flat, polished transparent glass or plastic disc or lens 18 glued or bonded to the annular shoulder 17, thereby separating the upper cylindrical portion 16A from the lower cylindrical portion 16B while allowing the transmission of a light beam of the microscope (not shown) through the lower and upper cylindrical portions. As the microchamber 57 will be located inside the upper cylindrical portion 16A when the container is properly positioned in the transverse docking passage 12 and the optical quality main flat sidewalls of the microchamber located substantially perpendicular to the axis of the observation chamber 15, the light beam will be directed through the opposed main flat sidewalls of the microchamber 57, thereby providing good light diffusion for good observation conditions of the embryo(s) even under high magnification. The observation chamber 15 will in practice be in a vertical position (as illustrated in FIGS. 1, 2 and 3) when the light beam is directed upwardly therethrough. In practice, the level of the oil or other suitable transparent relatively high refractive index liquid in the observation position of the block as shown in FIG. 3 ensures the part of the chamber in the container unit to be viewed, here the microchamber, is immersed in the oil or other suitable transparent liquid and one or more oil or other transparent liquid/vessel wall optical interfaces (around the microchamber in the illustrated embodiment) to eliminate or reduce the formation of undesirable artifacts.

Alternatively, the light beam may be directed horizontally (not shown), in which case the block 10 will be supported on its rear wall 33 with the front wall 33 becoming the top surface and the transverse docking passage 12 being located substantially vertically. Such an arrangement may be preferred when the embryo(s) or other biological matter is to be viewed with a video camera or a laser visual analysis beam located in line with and opposite the associated light source (not shown) but facing the outer end of the lower cylindrical portion 16B. When the block 10 is used in its vertical position, another glass disc or lens 18A (in phantom one) may be secured in an enlarged recess 13 in the top wall 30 and in communication with the upper cylindrical portion 16A, so as to seal chamber 20 containing oil or another suitable transparent liquid. The glass disc or lens 18 on the shoulder 17 between the upper and lower cylindrical portions 16A, 16B, may be eliminated and a disc or lens (not shown) provided at the outer end of the lower cylindrical portion 16B and for that purpose an enlarged recess can be provided in the bottom wall 31 at the end of the lower cylindrical portion.

In a simplified embodiment, the observation chamber 15 of the inspection block 10 also defines an immersion chamber containing oil or another suitable transparent liquid and is used for viewing embryos or other biological matter in the container unit received in a transverse docking passage 12. With such an arrangement there is the risk of spillage of oil or other suitable transparent liquid either when the oil or other suitable transparent liquid is emptied from the observation chamber 15 or the container unit is withdrawn from the transverse docking passage 12.

Preferably, the mineral oil, microscope oil, paraffin oil or other relatively high refractive index liquid functionally matches the refractive index of the wall(s) of the chamber of the container unit which for example may be made of polycarbonate, polystyrene or polyester. The oil or other suitable transparent liquid may have a refractive index between about 1.45 and about 1.65 and in practice between about 1.50 and about 1.60. Mineral oil or microscope oil has been found to be satisfactory, in particular Type B microscope immersion oil available from Cargille Laboratories, having a refractive index of 1.515. Alternatively, paraffin oil having a refractive index of about 1.50 to about 1.55 may be suitable. More generally, any other nontoxic transparent oil or liquid preferably having an index of refraction of between about 1.45 and about 1.65 and more preferably between about 1.50 and about 1.60, may be used suitable for functionally matching the refractive index of the wall of the microchamber or other chamber containing the biological matter, e.g. embryo(s). For example, polycarbonate has a refractive index of about 1.58, polystyrene has a refractive index of about 1.59 or polyester having a refractive index of about 1.53 are transparent plastics suitable for use for the microchamber or other chamber to contain biological matter including embryos.

As illustrated in the drawings, the inspection block 10 may include an oil or other transparent liquid longitudinal bore or reservoir 40 for collecting or storing the oil or other suitable transparent liquid transferred from the observation chamber 15, so as to be able to introduce and remove the container unit from the transverse docking passage 12 without the risk of oil or liquid spillage. The reservoir 40 has end caps 45 at its respective ends. The reservoir 40 also may also have on the respective sides of the central observation chamber 15 a pair of passageways which are inclined and communicate between the reservoir and the top wall 30 for venting or purging air from the reservoir.

The oil or other transparent liquid reservoir 40 is in communication with the observation chamber 15, either directly or, as shown, through a short channel 41 having an axis which is substantially perpendicular to the axes of the reservoir 40 and the observation chamber 15. The short channel is of cross section comparable to that of the cross section of the reservoir 40. In the observation position illustrated in FIG. 3, the level of the oil or other transparent liquid will, of course, be higher than the transverse docking passage 12, so that the chamber of the container unit and in particular the portion thereof containing the biological matter to be microscopically observed is immersed in the oil or other transparent liquid. In order to remove the container unit from transverse docking passage 12 without spillage, the block 10 is tilted to the loading/unloading or standby position illustrated in FIG. 4, so that it is supported on the inclined wall 34. In that position, the reservoir 40 is located below the observation chamber 15 and therefore the oil or other transparent liquid in the observation chamber may return to the reservoir 40 and at the same time allow the oil or another transparent liquid on the container unit to drip off back into the observation or immersion chamber.

To prevent leakage and/or spilling of oil both in the observation position of FIG. 3 and the standby position of FIG. 4, a gasket 60 is sealingly mounted and optionally bonded or glued to an inwardly extending collar 64 on the inner sidewall of the block adjoining the observation chamber. The gasket itself comprises a pair of spaced outwardly protruding annular flanges 61, 62 which engage opposite sides of the collar 64. The gasket 60 has a tapered inwardly directed annular lip 65 having a configuration corresponding to the section of the wall of the main chamber it faces and is adapted to engage the wall to ensure fluidtightness when the container unit is received in the block in the observation position. The lip also serves to wipe the oil or other suitable transparent liquid from the sidewall of the container unit, here the vessel, as it is removed from the block, then in its unloading position. The orifice defined by the inwardly extending edge of the lip 65 is adapted to self-seal once the container unit is removed from the inspection block preventing inadvertent leaking when the level of the reaches the orifice in the standby position.

The docking passage 12 is defined by a docking sleeve 66 received in a transverse bore in the front side of the block forwardly of the gasket 60. The outer wall of the docking sleeve is cylindrical and the tightly fitted in or affixed to the transverse bore. The annular inner wall of the docking sleeve has a rearwardly tapered wall portion 67 adjoining the gasket and having a surface complementary to the surface of the outer wall of the container unit at that location. Forwardly of the tapered wall portion 67 is a cylindrical surface snugly mating with the O-ring 68 carried in a groove on the vessel when the container unit is received in position in the docking passage 12 to define a secondary seal. Between the tapered wall 67 and the cylindrical surface 68 is a steeply inclined annular connecting surface defining an abutment for positioning the vessel or other container unit relative to the inspection block and the microchamber or other chamber relative to the observation chamber.

Another glass disc or lens 18A may be received in the recess 13 at the top of the upper cylindrical portion 16A and bonded or glued in place thereby avoiding any risk of the oil or other transparent liquid leaking or spilling out from the outer end of the upper cylindrical portion 16A.

With this embodiment, when the inspection block 10 is not in use, it preferably lies in position on its inclined wall 34 (as shown in FIG. 4) or its rear wall 33, so that the oil or other suitable transparent liquid us stored in the reservoir 40 and oil or other liquid is substantially drained out of the observation chamber 15.

Prior to use, the inspection block is warmed in an incubator and stabilized at a temperature of about 37° C. Prior to observation of the biological matter, and in particular embryo(s) in the chamber of the container unit, the biological matter will be incubated either in a vagina or in a commercial incubator. In the case of incubation in a vagina, a further period of incubation of, say, 15 to 30 minutes in a commercial incubator may be desirable. After this step there will be sedimentation of the biological matter, e.g. embryo(s), which is connected in a desired zone of the container unit 50 such as the microchamber. The container unit is positioned in the transverse docking passage 12 with the O-ring 58 in contact with the associated recess or transverse docking passage of the block and with the opposed flat faces of the microchamber 57 perpendicular to the axis of the observation chamber 20. The block 10 may then be tilted back into its observation position (FIG. 3) where it bears on the bottom wall 31 and the observation chamber 20 is generally in an upright or vertical position. The block 10 with the container unit can be placed on a microscope stage, lit from below and viewed with a microscope through the outer end of the observation chamber 20. After embryo(s) observation and loading the embryo(s) into a transfer catheter, the container unit 50 is closed and the block is tilted to the FIG. 4 position, so that it bears on the inclined wall 34, or the rearwall 30 (position, not shown), the oil or other suitable transparent liquid returns from the observation chamber 20 to the reservoir 40 and then the container unit is removed from the transverse docking passage 12.

In this embodiment, the reservoir 40 comprises one or more communicating cylindrical bores 42 in the inspection block 10, preferably extending orthogonally to the axis of the observation chamber 20 and to the axis of the transverse docking passage 12. As illustrated, the reservoir 40 extends generally longitudinally relative to the inspection block 10. The bore(s) of the reservoir 40 may be drilled into the block when it is made of steel. To facilitate fabrication, the reservoir may comprise, as illustrated, one or more drilled bore sections 42 extending substantially from one end wall 35 to the opposite end wall 36. As illustrated, the reservoir 40 comprises three cylindrical bore sections: a pair of opposed larger-diameter bore sections 43 and smaller-diameter an intermediate bore section 44 extending therebetween. As illustrated, the outer ends of the larger-diameter bore sections 43 have respective plugs 45 closing the ends of the reservoir. Plugs may be threaded steel or plastic plugs in threaded engagement with a threaded portion of the larger diameter bore sections 43 or bonded or glued or otherwise mechanically secured. As the larger diameter bore sections 43 are located to either side of the smaller-diameter intermediate bore section 44, oil or other suitable transparent liquid will tend to flow into the intermediate bore section 44 under the force of gravity when the block rests on its bottom wall 31, inclined wall 34 or rearwall 33, thereby facilitating the flow of oil or other suitable transparent liquid from the reservoir 40 to the observation chamber 20.

As illustrated, vents 46 connect the reservoir 40 and in particular the larger diameter bore sections 43 to the top wall 30 of the block, thereby venting or purging any air in the reservoir 40 to the atmosphere and preventing the formation of bubbles inside the observation chamber 20 which could otherwise interfere with the satisfactory observation of biological matter, e.g. embryo(s). As illustrated, the vents 46 comprise oblique bores extending from the larger diameter bore sections 43 to the top wall 30 of the block 10, the oblique bores being symmetrical relative to a medium plane containing the axis of the observation chamber 20 and the transverse docking passage 12.

Alternatively, if the block is made of plastics material, the reservoir, observation chamber and transverse docking passages, as well as the associated components, may be molded into the block, thereby facilitating, and reducing the cost of, the manufacture of the inspection block and permitting a variety of alternative configurations of the reservoir, air vents, observation/immersion chamber, transverse docking passage while maintaining their respective functions and operating modes.

The inspection block 10 may incorporate a heating element (not shown) such as an electrical resistance with or without a suitable heat transfer fluid for maintaining the temperature of the block and the oil or another transparent liquid substantially constant between about 34° C. and 37° C. and preferably substantially constant at about 37° C.

In the foregoing embodiment, the oil or other transparent liquid is transferred from the observation chamber 20 to the reservoir 40 simply by tilting the block 10 between a standby position and an operative position. Alternatively, the oil or other transparent liquid may be transferred by means of a pump or piston. In an embodiment (not illustrated), one of the plugs may be luer lock system for coupling a syringe. Oil or other suitable transparent liquid can then be aspirated from the reservoir and/or from the observation chamber and stored in the syringe when the inspection block is not in use. When the inspection block is to be used, it is preferably warmed for about 90 minutes to about 37° C. along with the oil or other transparent liquid, either in the syringe or transferred back into the reservoir and/or observation chamber. The piston may remain in the reservoir or removed to facilitate storage. When the oil or other transparent liquid is transferred from the reservoir into the observation chamber, the piston will be in its fully inserted position, so that only the distal end thereof is outside the confines of the inspection block.

According to another non-illustrated embodiment, the reservoir itself comprises the body of a syringe and is equipped with a piston slidable in the body for drawing the oil out of the observation chamber and into the reservoir when the inspection block is not in use and returned to the observation chamber when the inspection block is to be used.

The bottom wall 31 may be equipped with at least two adjustable feet for use when the work bench or microscope plate not be sufficiently level. As illustrated the two adjustable feet 49 comprise set screws threadedly engageable with complementary threads in at least part of the bores 48 extended from the top wall 30 to the bottom wall 31 and located adjacent the respective end walls 35 and 36. The heads are accessible from above so that by “tightening” the set screws their lower ends protrude beyond the bottom wall 31. The adjustable feet 49 may be used to produce slight inclination of the block by raising the rear side thereof, so that the axis of the transverse docking passage and thereby the axis of the container unit is forwardly and downwardly inclined at an angle of between about 5° and about 15°. At such an inclination, the biological matter, e.g. embryo(s) will tend to move from the bottom wall of the microchamber to a position midway along the main sidewall of the microchamber, thereby facilitating the observation, selection and aspiration of the selected embryo(s) for transfer. Alternatively, but not illustrated, the bottom wall of the block may have an inclinable surface mounted on the bottom wall between a plurality of inclined positions and adjusted by means of screws or the like.

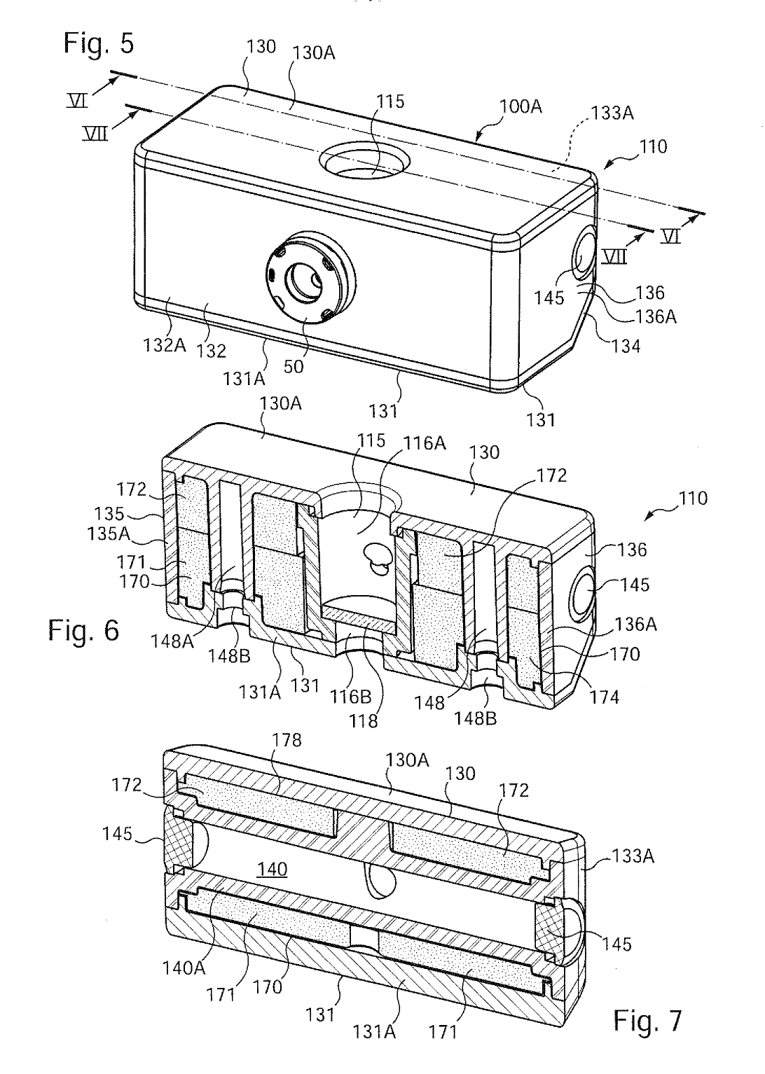

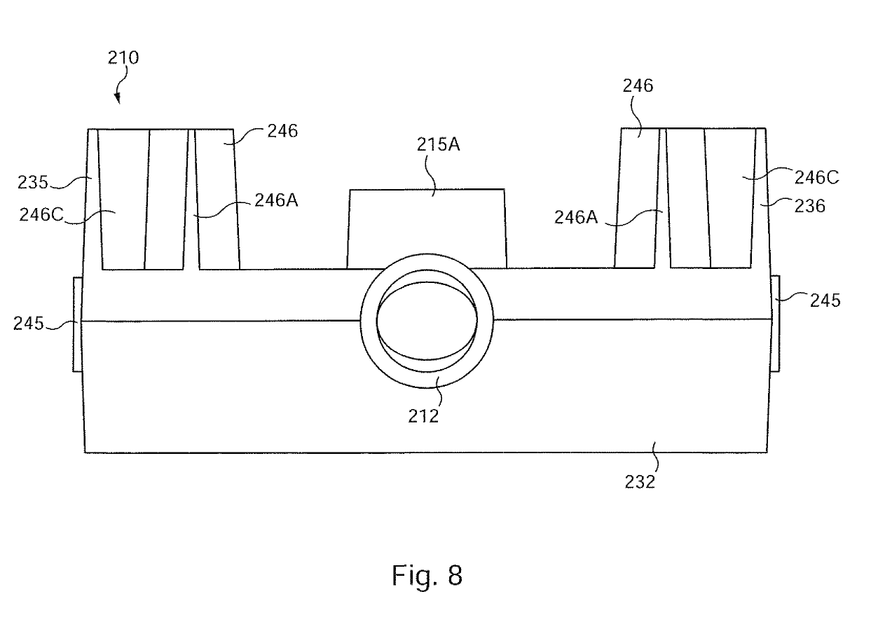

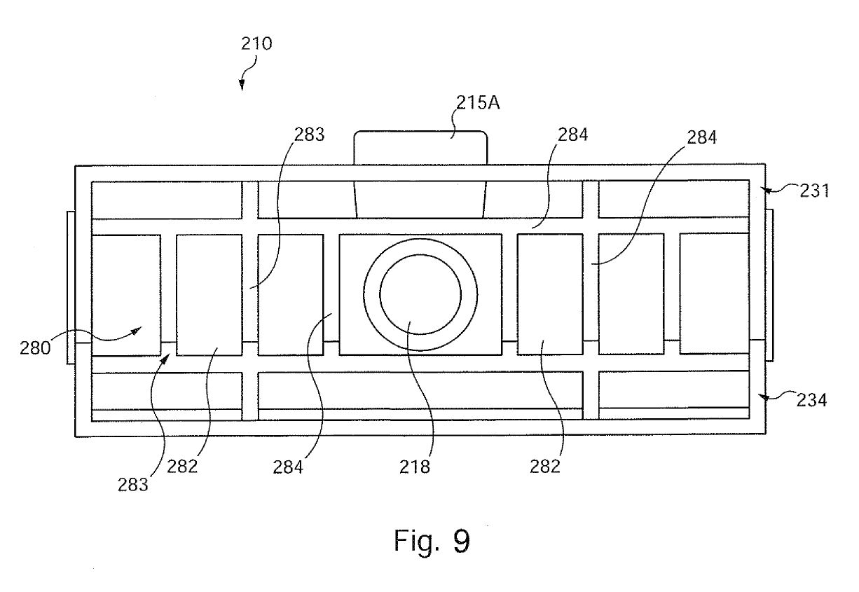

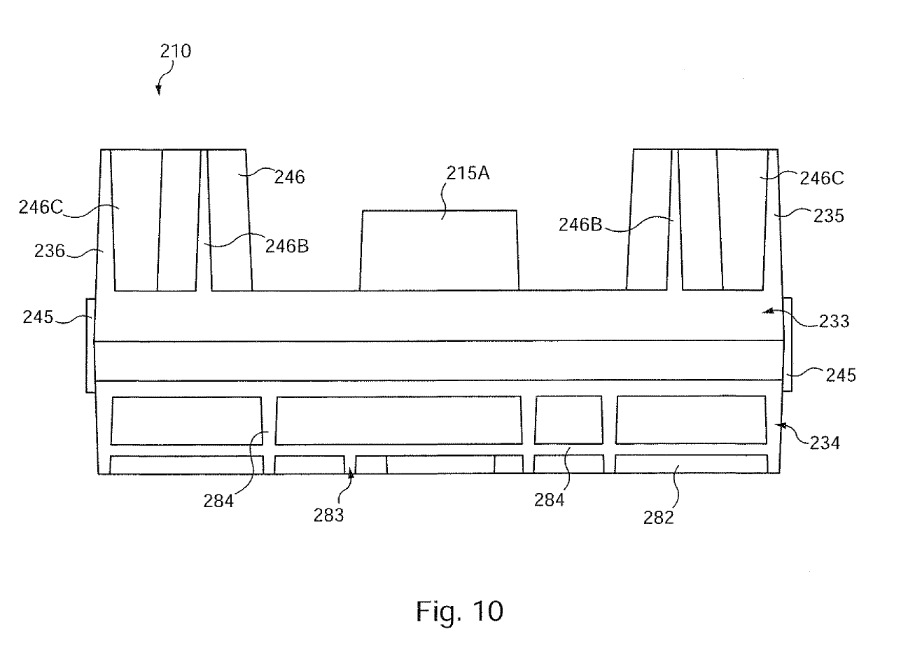

FIGS. 5-8 show second embodiment and FIGS. 8-11 a third embodiment of the inspection block which are made mainly or entirely of a plastic material having suitable properties such as polycarbonate, polystyrene or polyester. An inspection block made of plastic is advantageous from the standpoints of manufacturing cost and shipping cost owing to the reduction of weight and increased production rate. An inspection block made mainly or entirely of transparent plastic provides a higher level of lighting inside the observation chamber and therefore inside the container unit for viewing the embryo(s) or other biological matter in the chamber.

In FIGS. 5-8 like reference numerals increased by 100 correspond to the features disclosed above in respect to the first embodiment. Except as pointed out below the features, functions and operating mode of the second embodiment are the same as described above.

To improve the thermal insulating properties of the inspection block of the second embodiment, closed cavities are provided inside a hollow housing and accommodate insulating material having a high heat retaining capacity and a low thermal conductivity, such as expanded polystyrene which has a low thermal conductivity of 0.03 W/mK or even air which has a slightly lower thermal conductivity of 0.024 W/m K.

The hollow housing 110A of the inspection block 110 of the second embodiment is mainly or entirely made of plastic such as polycarbonate, polystyrene and polyester and may be partly or entirely transparent.

The hollow housing 110A of the inspection block 110 comprises a plurality of components including a top component 130A defining the upper wall 130, a bottom component 131A defining the bottom wall 131, end components 135A, 136A defining opposed end walls 135,136 and a central component 115A defining the cylindrical observation chamber 115 with an optical disc 18 between upper and lower portions 116A, 116B of the observation chamber. The reservoir 140 located proximate to the rear wall 133 is defined by a longitudinal tubular component 140A sealed off by end plugs 145. The transverse docking passage (not shown) for receiving the container unit is defined by separate cylindrical components and equipped with a gasket and is in fluid communication with the observation chamber 115 through one or more orifices. The reservoir 140 is likewise in fluid communication through orifices with the observation chamber 115 for ensuring the flow of oil or other transparent liquid therebetween. The hollow housing comprises closed internal closed cavities 170 which accommodate upper and lower insulating blocks 171,172 which have outer contours substantially mating with the inner contours of the hollow housing 110A. The top and bottom components 130A, 131A comprise aligned bore sections 148A, 148B for receiving corresponding threaded fasteners (not shown). The threaded engagement of the threaded fasteners with the bore sections assemble and secure the components of the hollow housing and the insulating blocks 171,172 together. When the cavities in the hollow housing 110A are to be filled with air, air seals may be provided between the engagement surfaces of the respective components of the hollow housing to ensure air tightness of the cavities.

The third embodiment of the inspection block is advantageously a relatively thin-walled structure of transparent plastic so that nearly the entire block 210 can be produced as a single injected molded component 210A. The longitudinal bore or reservoir 240 is preferably closed by separate end plugs 246 which may welded, bonded or glued to the end walls 235, 236 of the block, sealing the ends of longitudinal bore or reservoir. Further as the observation block of the third embodiment is thinned walled throughout, no wall exceeding about 5 mm and in practice not more than about 3 mm, it is advantageously possible to obtain high extrusion molding through puts.

The third embodiment of the inspection block advantageously comprises a passive heat collector 270 which captures heat from a warmed microscope stage or platform (not shown) on which the inspection block is intended to be positioned in its observation position and/or from a warmed work bench (not shown). In this embodiment the lower part of the observation block may have one or move downwardly opening air pockets or cavities 272. Preferably the lower part of the block is equipped with an array of downwardly extending fins 273 defining a plurality of air pockets or cavities 272 for collecting heat given off by the microscope and/or the warmed work bench.

This third embodiment is therefore highly advantageous in that it is both lightweight and inexpensive to fabricate, and incorporates a built-in passive heat collector 270 which avoids the need for an active heat source or special insulating materials incorporated in the body of the inspection block.

In FIGS. 8-11 like reference numerals increased by 200 correspond to the features disclosed above in respect to the first embodiment. Except as pointed out below the features, functions and operating mode of the third embodiment are essentially the same as described above.

The inspection block 210 of the third embodiment comprises as noted above a passive heat collector 270 which captures heat from the heating source on the stage or platform (not shown) on which the observation block is intended to be positioned in its observation position and/or from a warmed work bench on which the microscope is supported.

In this embodiment the passive heat collector 280 is provided on the bottom wall 231 of the inspection block and comprises has one or more downwardly opening air pockets or cavities 282. To this end the bottom wall 231 is equipped with an array 283 of downwardly extending fins 284 defining a plurality of air pockets or cavities 282 for collecting heat given off by the warmed microscope platform or stage (not shown) and/or the warmed work bench (not shown). The fins 284 include longitudinal fins extending in the longitudinal direction and transverse fins which extend in a direction perpendicular to the longitudinal fins. In the illustrated embodiment the passive heat collector 280 is not only provided on the bottom wall 231 but also on the inclined wall 234 so that the passive heat collector 280 is operative in both the observation and the standby positions of the inspection block.

The passive heat collector 280 may comprise for example a single or smaller number of air pockets or cavities 282 than as shown but preferably with be enclosed around its entire perimeter to avoid lateral outflow of the heated air from the passive heat collector. Likewise the array 283 of downwardly opening fins 284 need not be linear or parallel and perpendicular to the longitudinal direction. Tests with the third embodiment of the inspection block show that it is possible to maintain the inspection block initially heated to a stabilized temperature of 37° C. at least about 34° C. for a minimum period of 12 minutes when the inspection block is heated by heat given off from a heated microscope and/or a warmed work bench.

Finally, air vents 246 in communication between the reservoir 240 and the surrounding ambient air may comprise upstanding venting chimneys of hollow cylindrical configuration as illustrated. Reinforcement ribs 246A, 246B, 246C extending respectively forwardly (246A) and rearwardly (246B) from the chimneys and longitudinally (246C°) which intersect upstanding walls portions of the end walls 235, 236 of the inspection block.

Moreover, the illustrated third embodiment admits of injection molding the substantially entire block in a single piece other than the end caps 245 closing off the respective ends of the reservoir 240 for the transparent liquid which end caps are secured to the block by threaded engagement or welding, bonding or by an adhesive.

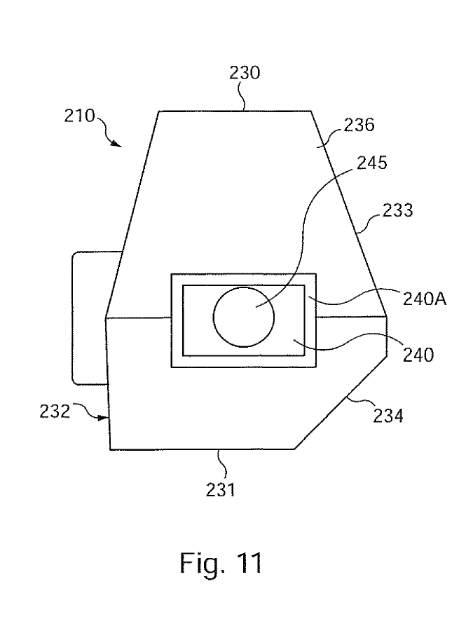

Further, the reservoir 240 comprises one or more sections which are rectangular in cross section with the longer dimension being horizontal (see FIG. 11) in the observation or inspection position of the block which enables the level of the same amount transparent oil to be well below the transverse docking passage 212 so that the gasket 60 may be eliminated entirely without any risk of leakage or spilling of the transparent liquid.

It will be understood that various modifications may be adopted without departing from the scope of the invention defined in the appended claims. For example, features of one of the embodiments may be incorporated in another of the embodiments. Thus, the first or second embodiment may be provided with a passive heat collector including an array of downwardly extending fins defining one or more downwardly opening air pockets or cavities. The first or third embodiment may include enclosed cavities accommodating insulating blocks. While the first, second and third embodiments will not normally require any active heating element, such a heating element may of course be provided if desired or necessary. Constituent materials for the inspection block need not be those described herein and like was the non-toxic transparent liquid need not be an oil such as mineral oil, microscope oil or paraffin oil. Finally, it goes without saying that the geometrical and structural features of the embodiments disclosed are in no way limitative.

There is claimed:

1. An inspection block for use in inspection of biological matter in a container unit having a chamber with transparent walls, said inspection block having a bore for receiving and positioning a container unit, an observation chamber extending transversely relative to the bore and in communication therewith such that the biological matter located inside the container unit may be microscopically inspected through the chamber walls, transparent liquid for immersing at least part of the container unit so as to define a chamber wall/liquid optical interface for microscopic inspection therethrough.

2. The inspection block according to claim 1, further comprising a reservoir for temporary storage of a transparent liquid when the inspection block is not in use.

3. The inspection block according to claim 2, wherein said reservoir is in communication with the observation chamber.

4. The inspection block according to claim 3, wherein the inspection block has a standby position where the transparent liquid is stored in the reservoir and an inspection position where the transparent liquid immerses at least part of the container unit in the observation chamber.

5. The inspection block according to claim 4, wherein the inspection block has a first wall surface for supporting it in the standby position and a second wall surface for supporting it in the inspection position.

6. The inspection block according to claim 5, wherein the second wall surface is an inclined wall surface for defining a tilted position of the inspection block.

7. The inspection block according to claim 4, wherein the transparent liquid flows from the reservoir to the immersion chamber and from the immersion chamber to the reservoir under the force of gravity.

8. The inspection block according to claim 4, further comprising a pump or piston for transferring transparent liquid from the reservoir to the observation chamber and/or from the observation chamber to the reservoir.

9. The inspection block according to claim 1, wherein the bore is a horizontal transverse docking passage and the observation chamber is a vertical bore when the block is in its observation position.

10. The inspecting block according to claim 1 wherein the block is made mainly of metal and includes a light window aligned with the observation chamber in the observation position of the block.

11. The inspection block according to claim 10, wherein the inspection block is made mainly or entirely of plastic material including a transparent plastic light window.

10. The inspection block according to claim 3, wherein the reservoir and the observation chamber comprise a transparent liquid circuit, the inspection block having at least one passageway for purging air from the transparent liquid circuit.

11. The inspection block according to claim 1, wherein the index of refraction of transparent walls of the container unit and transparent liquid is between about 1.45 and about 1.65.

12. The inspection block according to claim 1, wherein transparent walls of the chamber are made of a plastic material selected from the group consisting of polycarbonate, polystyrene and polyester.

13. The inspection block according to claim 1, wherein the transparent liquid is selected from the group consisting of microscope immersion oil, mineral oil, and paraffin oil.

14. The inspection block according to claim 1, wherein the block is made of a material having a high thermal inertia.

15. The inspection block according to claim 1, wherein the block has one or more downwardly opening air pockets for retaining heat given off from below.

16. The inspection block according to claim 14, wherein the block is made essentially or entirely of plastic material at least portions of which are transparent for microscopic inspection therethrough.

17. The inspection block according to claim 16, wherein the block comprises a hollow housing having one or more cavities containing insulating foam or gas.

18. The inspection block according to claim 1, wherein a gasket engages the container body when it is received in the block and has a lip for wiping the transparent liquid off the container body wall during the removal of the container body from the inspection block and/or impeding or preventing sea page of the transparent liquid when the container is received in the inspection block.

19. Method of microscopically inspecting biological matter including embryos comprising providing a container having a chamber with transparent walls of optical quality, loading the container with biological matter and a compatible culture medium, providing a transparent liquid having an index of refraction functionally matching the index of refraction of the transparent walls, providing a transparent liquid interface with the transparent walls of optical quality, viewing the biological matter in its initial stage or a further development stage through an interface defined by the transparent walls and the transparent liquid.

20. Method according to claim 14, wherein the indexes of refraction of the transparent walls and transparent liquid are between about 1.50 and about 1.60.

21. Method according to claim 14, wherein the transparent walls are made of a plastic material selected from the group consisting of polycarbonate, polystyrene and polyester.

22. Method according to claim 14, wherein the transparent liquid is selected from the group consisting of microscope oil, mineral oil and paraffin oil.

23. Method according to claim 14, wherein the container is at least partiality immersed into an observation chamber of the inspection block containing the transparent liquid, a light source being located beyond one end of the observation chamber and a microscope being located beyond an opposite end of the observation chamber.

24. An inspection block for use in inspection of embryos in an embryo container having at least a transparent wall for microscopic inspection, the inspection block having a docking passage for receiving and positioning an embryo container unit, an observation chamber extending transversely relative to the bore and containing a transparent liquid, the observation chamber being in communication with the docking passage, such that embryos located inside the container unit may be microscopically inspected in the observation chamber through a transparent liquid optical interface with at least one transparent wall of the embryo container.

25. A method of microscopically observing biological matter including embryos in a suitable biological medium and accommodated in an at least partly transparent walled chamber, comprising the steps of: immersing at least part of the chamber in a transparent liquid, so that the transparent liquid defines an optical interface with an external surface of the at least partly transparent chamber and observing the biological matter in the transparent walled chamber through the optical interface and thereby reducing or eliminating artifacts caused by the chamber walls.

26. A method according to claim 21, wherein the transparent liquid is contained in block and the block is preheated prior to immersing the at least part of the chamber in a transparent liquid.

27. A method according to claim 22, wherein the block is made of a high heat retaining material and the temperature of the preheated block is about 37° C. and falls less than 3° C. when exposed to an environment at about 23° C. for less than 8 minutes.

28. A method according to claim 22, wherein block is positioned on a heated bench and/or a warmed microscope stage during the observation of the biological matter and the block has a downwardly extending array defining air pockets for retaining heat given off by the warmed work bench and/or warmed microscope stage.

29. An inspection block for use in inspection of biological matter in a container unit having a chamber with transparent walls, said inspection block having a bore for receiving and positioning a container unit, an observation chamber extending transversely relative to the bore and in communication therewith such that the biological matter located inside the container unit may be microscopically inspected through the chamber walls, the inspection block being of thin-waited construction and having one or more downwardly opening air pockets retaining heat given off by a warmed work bench and/or warmed microscope stage.
